(19) United States
(12) Patent Application Publication
(10) Pub. No.: US 2018/0041826 A1
(43) Pub. Date: Feb. 8, 2018

(54) WEARABLE DEVICE FOR LISTENING TO SOUND

(71) Applicant: PUGZ GEAR AB, Stockholm (SE)

(72) Inventors: Hamid Toosi, Stockholm (SE); Vahid Toosi, Stockholm (SE)

(73) Assignee: PUGZ GEAR AB, Stockholm (SE)

(21) Appl. No.: 15/503,693

(22) PCT Filed: Apr. 27, 2016
(86) PCT No.: PCT/EP2016/059389

§ 371 Date: Feb. 13, 2017

(30) Foreign Application Priority Data
Apr. 27, 2015 (SE) 1550504-3

(51) Int. Cl. H04R 1/10

(52) U.S. Cl. CPC H04R 1/1025; H04R 1/1033; H04R 1/1016

(57) ABSTRACT

There is provided a wearable device for listening to sound comprising two in-ear earbuds capable of reproducing sound, where said two in-ear earbuds are attached to each other with a cord, said cord comprising cable parts with leads for powering the device and for transmitting signals, the length of said cord being adapted to reach around the back of the neck of a user of the device, said device having a wireless connection unit, where the wireless connection unit is capable of receiving a wireless digital signal and provide a wire bound signal to the two in-ear earbuds for reproducing sound in the earbuds, said device having a battery and a charging interface for connecting a charging cable for charging the battery, characterized in that said charging interface is located on the cord.

### FIELD OF THE INVENTION

This invention relates to a wireless wearable device, so called in-ear earphones, for listening to sound, for example music.

### BACKGROUND

The smartphone is today perhaps the major platform for providing music to consumers. The smartphone may, for example, play music in mp3 file format or stream music from music stream providers, such as Spotify. In-ear earphones (also referred to as in-ear headphones) are frequently used when listing to music from a smartphone. In-ear earphones are earphones that are partly inserted into the ear canal of the user. Such in-ear earphones may have a microphone for sensing for example the voice of the user. This makes it possible to also use the in-ear earphones for carrying out a telephone conversation.

Recently, wireless such in-ear earphones have been launched on the market. Such in-ear earphones have a battery and a wireless connection, for example a Bluetooth connection, for providing a digital sound signal, from for example a smartphone, to the earphones.

The wireless earphones of the Jabra Rox brand is an example of such in-ear earphones. The battery of the Jabra Rox earphones is charged by connecting micro-USB plug to a micro-USB receptacle integrated in one of the earbuds. This has several drawbacks. It is difficult to attach the charging cable to the earbud during use because the rather small micro-USB plug must be inserted into a micro-USB receptacle which is not visible to the user because it is located in the ear of the user. Moreover, the micro-USB receptacle is located behind a door in the earbud that must be first be opened. It is very difficult to open the door and insert the USB plug when the earbud is inserted into the ear. Moreover it is uncomfortable when the charging cable is protruding from the ear during charging. In summary, it is difficult to charge the Rox Jabra headphones when the earbuds are in the ears of the user. Therefore the Jabra Rox headphones are normally removed from the ears when they are to be charged.

The Rox Jabra headphones are automatically rebooted when the USB-plug is inserted into receptacle. This causes the sound from the earphones to be the switched off. Thus the user can not charge the Jabra Rox earphones while listen to music or carrying out a telephone conversation.

Since it is very difficult to charge the in-ear earphones of the prior art during use, the user must cease listening to music or interrupt the telephone conversation if the battery charge becomes too low during use.

The invention solves these and other problems.

### SUMMARY OF THE INVENTION

There is provided a wearable device for listening to sound comprising a first in-ear earbud and a second in-ear earbud capable of reproducing sound, where said two in-ear earbuds are attached to each other with a cord, said cord comprising leads for powering the device and for transmitting signals, the length of said device being adapted to reach around the back of the neck of a user, said device having a wireless connection unit, where the wireless connection unit is capable of receiving a wireless digital signal and provide a wire bound signal to the two in-ear earbuds for reproducing sound in the earbuds, said device having a battery and a charging interface for reversibly connecting a charging cable for charging the battery, characterized in that the charging interface (6) is located on the cord closer to the first earbud than the second earbud and in that the distance from the first earbud to the charging interface is from 100 mm to 220 mm such that the charging interface, when the device is worn by a user, will rest on the shoulder of the user.

The device which may be referred to as a pair of in-ear earphones, is intended to be worn with the cable around the back of the neck of a user with one earbud in each ear.

Wearing the device with the cord around the back has several advantages.

If the user momentarily does not want to user the headphones they can hang around the neck where they are easily accessible for use. Completely removing the headset when not using it is cumbersome and involves the risk that the cord becomes tangled.

This type of headphones are kept in place with a “pressfit” in the ear channel. However, wireless headphones are rather heave since they have to have a battery, wireless circuit and such. These do not fit inside the early but will protrude somewhat outside the ear channel. The weight of these parts may risk to pull out the earbud, in particular when the user moves.

The inventive design has several advantages. It places the charging interface at a convenient location but where it still does not risk to pull out the earbud with its weight. The asymmetric location of the charging interface ensures that it will rest on the shoulder where it will not pull out the closest earplug with its weight. It will rest on the shoulder which makes it easier to attach the charging cable.

Yet another advantage with the invention compared to the Jabra Rox is that the charging cord does not protrude from the ear when charging during use.

In order to achieve that the charging interface rests on the shoulder of the user, the length of the cord from the charging interface to the nearest of the two is preferably from 100 mm to 220 mm, more preferably from 120 mm to 200 mm, more preferably from 140 mm to 180 mm and most preferably from 150 mm to 170 mm.

Preferably the wearable device does not cease to emit sound when the charging cable is connected to the charging interface.

This has the advantage that the user does not have to interrupt a telephone conversation or listening to music just because he or she has to charge the battery of the device.

Preferably the charging cable can be reversibly attached to the charging interface with the aid of magnetism.

This has the advantage that the charging cable is guided to charging interface by the use of a magnetic force. It makes it very simple to attach the charging cable since the user only have to touch the charging interface to the charging interface to attach it. An advantage with this is that it makes it easier for the user to connect the charging member without visual guidance.

The device may additionally comprise a control interface located on the cord closer to the second earbud than the first earbud. This has the advantage of providing a balanced device where the weight pulls equally (or almost equally) on both earbuds.

In a second aspect is provided the use of a device according to the invention where the device is worn with the cord around the back of the neck. The device is intended to be worn with the cable around the back of the neck of a user with one earbud in each ear. When worn this way the charging interface which is located on the cable of the device will be easily accessed for charging during use. The user can simply click in the charging cable in place and continue to listen to music or continue the telephone conversation even under low battery conditions.

### BRIEF DESCRIPTION OF DRAWINGS

FIG. 1a is a schematic view of a device being used by a user.

FIG. 1b shows an example of the device.

FIG. 1c shows the device being worn by a user and shows how the charging interface rests on the front of the shoulder of the user.

FIG. 2-5 are schematic overviews of devices.

FIG. 6 is an example of a charging interface connected to a charging cable.

FIG. 7 is a schematic cut-through view of the charging interface connected to a charging member.

FIG. 8 are examples of the charging interface and the charging member.

FIG. 9 is an example of the back side of the charging interface.

FIG. 10 schematically shows an example of a charging interface.

### DETAILED DESCRIPTION

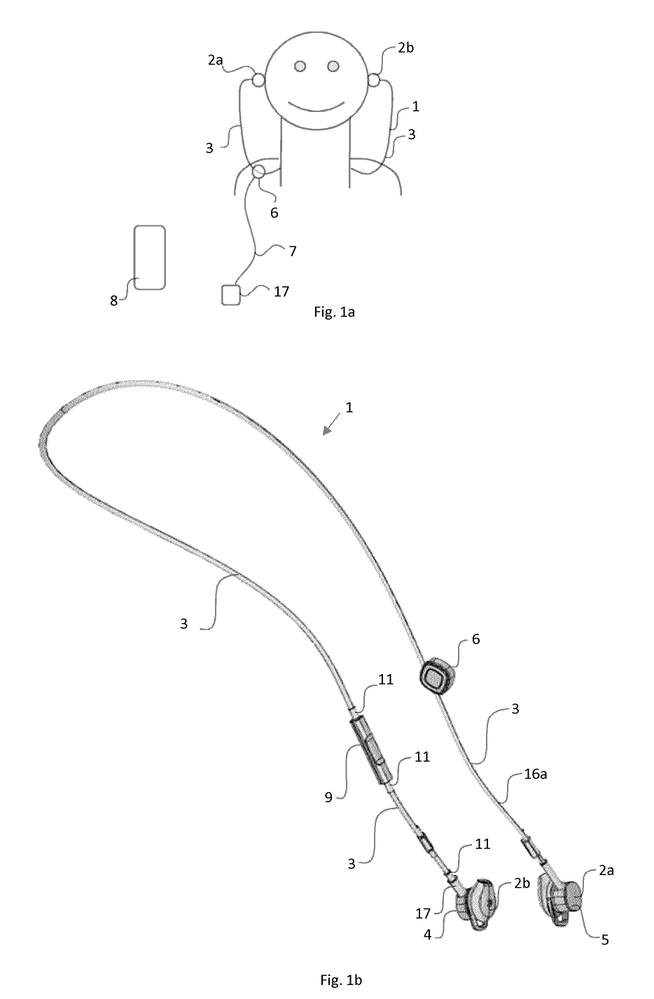

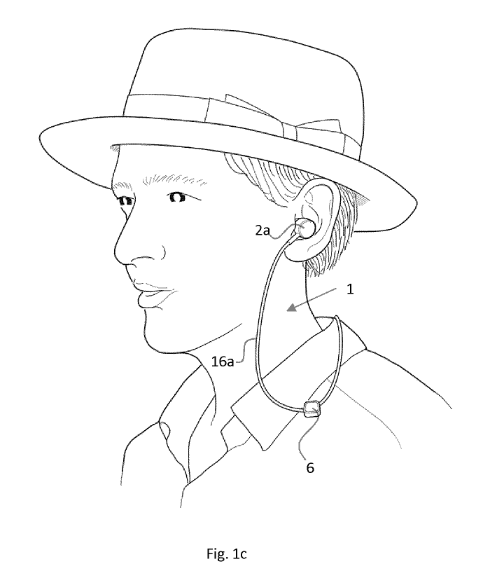

With reference to FIGS. 1a and 1c, the device 1 is intended to be worn with the cord 3 around the back of the neck of a user with one earbud 2a 2b in each ear. When worn this way the charging interface 6 which is located on the cord 3 of the device 1 will be easily accessed for charging during use. The user can simply click in the charging cable 7 in place and continue to listen to music or continue the telephone conversation even under low battery conditions.

With reference to FIG. 1b, each of earbuds 2a 2b are attached to cord 3. The cord 3 attach the two earbuds 2a 2b to each other. The cord 3 is preferably flexible such that the device 1 for example can be rolled by hand into a skein that fits in the pocket. The cord 3 may comprises at least cable parts 16a and 16b and charging interface 6. Cable parts 16a and 16b contribute to the flexibility of the device 1. However, certain parts of the cord 3 may be non-flexible. The cord 3 may also comprise other parts such as control interface 9. Thus, as used herein “cord” may include other parts than the cables 16a, 16b and 16c.

Each of earbuds 2a and 2b are designed to be partly or wholly inserted into the ear canal of the user. Thus at least a part of earbuds 2a and 2b have shape and a size to fit in the ear canal, and to remain there during use. Earbuds 2a 2b may have asymmetrical shapes such that one earbud is intended to be inserted into the left ear and one earbud is intended to be inserted into the right ear. Earbuds 2a 2b have small loudspeakers that are capable of receive an electrical signal (digital or analogue) from wireless connection unit 4 and emit sound. The signal travels in leads in cord 3.

A part of earbud 2a 2b may protrude from the ear canal during use. One such part of earbud 2a or 2b may comprise for example the battery 5 or the wireless connection unit 4, or both.

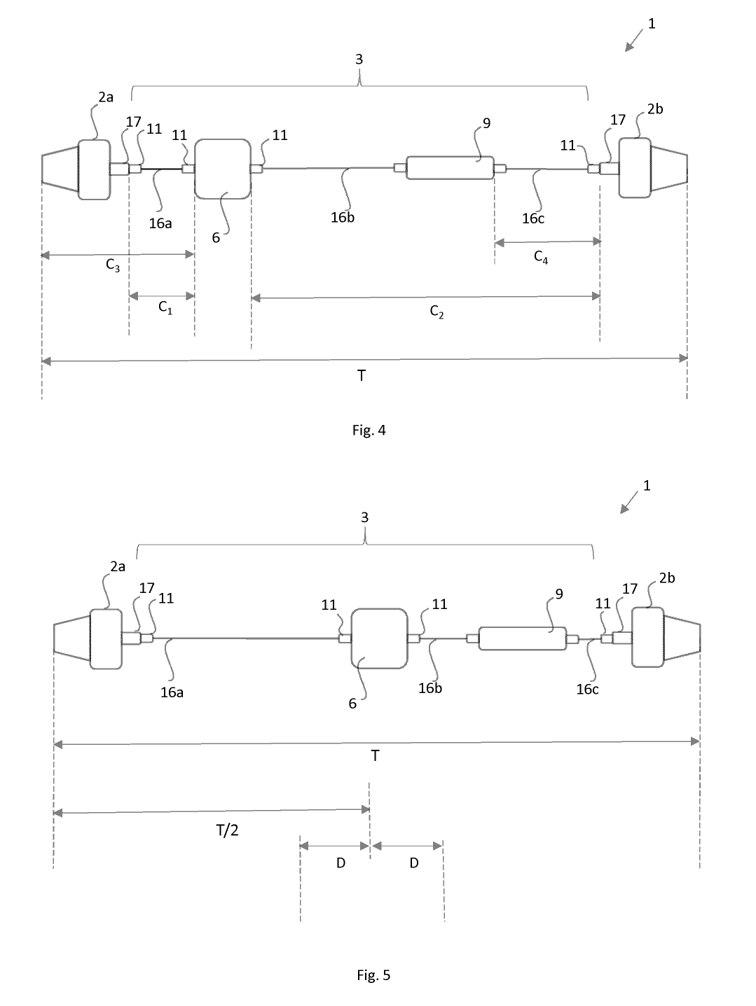

Each of earbuds 2a 2b may have a pipe 17 for leading a part of cable parts 16a and 16b. The parts of the cable parts 16a and 16b closest to the earbuds 2a 2b may each be covered by a strain relief 11 of flexible polymer material for protecting this part of the cables from twisting and bending damages. Such strain relieves 11 may be present along other parts of the device 1 as can be seen in FIGS. 4 and 5.

The device has a wireless connection unit 4 for receiving a wireless digital signal from a wireless device 8 (FIG. 1a) such as a smart phone or a tablet computer, such as an Ipad. The wireless connection may be a Bluetooth connection such that the device 1 and the wireless device 8 are pair coupled with a Bluetooth connection. The connection could also be a Wi-Fi connection. The wireless connection provides a digital signal to the wireless connection unit 4 which signal is transformed to a wire bound signal which is provided to the two earbuds 2a and 2b. The wire bound signal travels to the earbuds 2a 2b in leads in the cord 3. The wireless connection unit 4 may be integrated into one of the two earbuds 2a 2b. The wireless connection may also be used for sending a signal from device 1 to wireless device 8, for example during a telephone call.

The device comprises at least one battery 5 for powering the device. The battery 5 may preferably be integrated into one of the earbuds 2a 2b.

Preferably the battery 5 is integrated into one of earbuds 2a 2b and the wireless connection unit 4 is integrated into other earbud 2a 2b. Thereby a balanced device with approximately the same sized earbuds 2a 2b can be obtained.

The battery 5 is charged through charging interface 6 where the user may connect a charging cable 7. The charging cable 7 can be connected to an electrical power source 17 that provides a charging current to battery 5 trough charging interface 6. The power source 17 may for example be a power transformer and a power outlet. Alternatively the user may choose to connect charging cable 7 to another battery powered device, for example a laptop computer.

The device 1 preferably has a control interface 9 for allowing the user to switch on and off the device 1 and for controlling the volume. The control interface may also allow the user to jump to next music track, accept and hanging up telephone calls, etc. The control interface 9 may have buttons for operation of device 1 by the user. The buttons of the control interface 8 may be such that pressing the button for different lengths of time has different effects. The control interface 9 may have a LED light that shows the status of the device 1, in particular the status of the battery 5. The device 1 may have a microphone. The microphone can be used for making telephone calls. The microphone may be integrated into the control interface 9.

The cord 3 comprises a number of leads for providing signals and power to and from various part so of the device 1 as is understood in the art. Cable parts (for example cable parts 16a 16b) comprise such leads. There are at least two leads (+ and −) from the charging interface 6 to battery 5 for providing a charging current to battery 5 when charging cable 7 is connected to charging interface 6. There are also at least two leads (+ and −) that supplies power from the battery 5 to the wireless communication unit 4. There are also leads that provides at least a signal for providing sound from the wireless communication unit 4 to each of the earbuds 2a 2b. The control interface 9 is also connected with leads to other components of the device 1. Thus the cord 3 may contain a number of different leads for different purposes, such as power, control signals and electronic sound signals.

The charging interface 6 is located on the cord 3. The charging interface 6 is thus attached to earbuds 2a 2b with the cord 3. There is at least some cable 16a between earbud 2a and charging interface 6 and at least some cable 16b between charging interface 6 and earbud 2b.

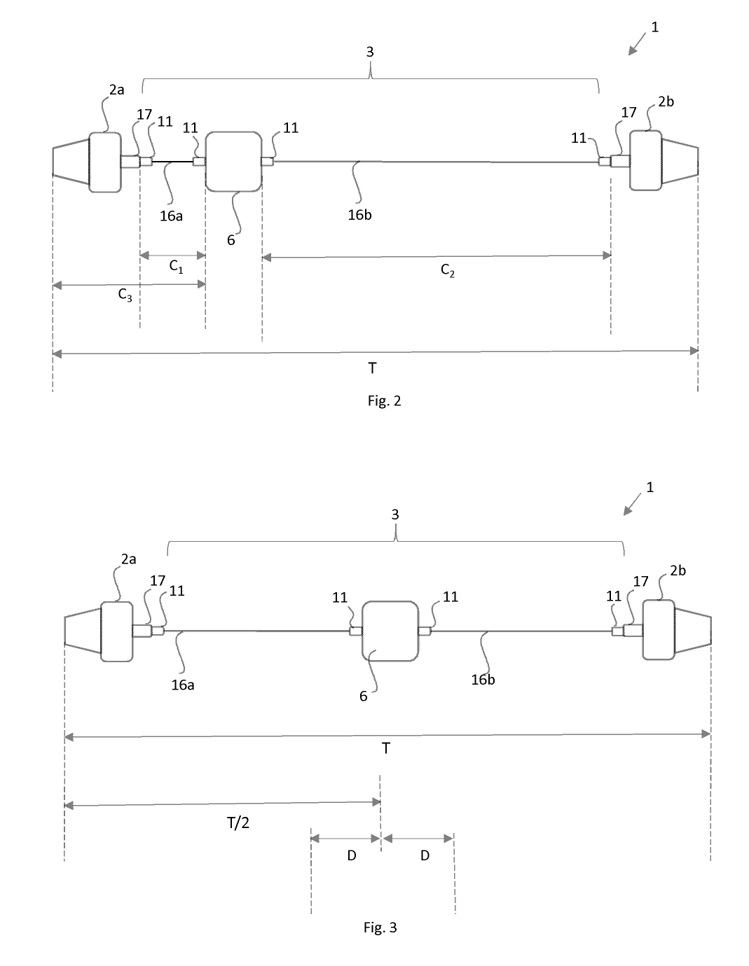

FIG. 2-5 schematically shows the device 1 laid out along a straight line. The total length T of device 1 is preferably from 500 mm to 700 mm, more preferably from 550 to 660 mm, more preferably from 580 to 640 mm, and most preferably from 600 to 620 mm. The total length T of the device is measured from one earbud 2a to the other earbud 2b when the device is laid out a long a straight line. The total length of the device includes cord 3 (here comprising cable parts 16a and 16b and charging interface 6) and earbuds 2a 2b. The length of the cord 3 may also comprise other parts such as control interface 9.

FIG. 2 schematically show cable parts 16a and 16b between the charging interface 6 and each of the earbuds 2a 2b. The distances C₁ and C₂ between the charging interface 6 and each of earbuds 2a 2b is preferably at least 100 mm, more preferably 120 mm even more preferably at least 140 mm and most preferably at least 155 mm. Thus cable parts 16a and 16b may have lengths to obtain such a distance. This distance ensures that the charging interface 6 in most cases rests on the shoulder or on the neck of the user, and does not hang suspended in the air. This depends to some extent on the length of the neck of the user. If the charging interface hangs suspended in the air, its weight may pull the closest ear plug 2a from the ear, which is undesirable.

The distances C₁ and C₂ from the charging interface 6 to the two earbuds 2a 2b includes the strain relief 11, but does not include pipe 17, which is a part of earbud 2a 2b.

In a preferred embodiment C₁ and C₂ are different such that one earbud 2a (first earbud) is closer to the charging interface 6 than the other earbud 2b (second earbud). Preferably the distance C₁ from the charging interface 6 to the nearest of the two earbuds 2a is such that the charging interface 6, when the device is worn by a user, will rest on the shoulder of the user, preferably on the front of the shoulder of the user as seen in FIGS. 1a and 1c. This area may also be referred to as the clavicle region of the user. A suitable distance for optimal user friendliness is from 100 mm to 220 mm, more preferably from 120 mm to 200 mm more preferably from 140 mm to 180 mm, and most preferably from 150 mm to 170 mm. A preferred distance is 160 mm. Thus cable 16a may have this length. The preferred length C₃ (FIGS. 2 and 4) from the end of the device 1 closest to the charging interface 6 (this is the end of first earbud 2a) to the charging interface 6 is from 120 mm to 220 mm, more preferably from 140 mm to 210 mm, more preferably from 160 mm to 200 mm and most preferably from 170 mm to 190 mm. A preferred distance is 180 mm.

Alternatively, the distance from the charging interface 6 to the two in-ear earbuds 2a 2b is such that the charging interface 6 is about halfway between the earbuds 2a 2b as shown in FIG. 3. This location is also user friendly and has the effect that the charging interface 6 will rest on the middle of the back of the neck of the user. Also, this makes it easy to wear the device 1 with the cord 3 in front of the neck. The charging interface 6 will then be halfway in between the earbuds 2a 2b and will pull equally hard on both earbuds 2a 2b, which lessens the risk of pulling out any of the earbuds 2a 2b during charging. This is achieved when the charging interface 6 is located in the middle or close to the middle of the length of the device 1. Preferably the charging interface 6 is located within a distance D from the middle of the total length T of the device, which distance D preferably is 5%, more preferably 2% and most preferably 1% of the total length T.

The preferred distances described above can be obtained by the cable parts 16a and 16b having appropriate lengths. However, other parts of the device 1 may contribute to the distance between the charging interface 6 and earbuds 2a 2b, as shown in FIGS. 4 and 5, where the cord 3 includes control interface 9 and cable parts 16a, 16b and 16c.

The control interface 9 is preferably located on the cord 3, of device 1, but at the opposite side from the charging interface 6 as shown in FIG. 4. This has the advantage of balancing the device 1. The control interface 9 is not as heavy as the charging interface 6 and charging member 10 so the control interface 9 may be suspended when the device 1 is worn by the user. A suitable distance from second earbud 2b to control device 9 (distance C4 in FIG. 4) may then be from 20 mm, more preferably from 30 mm to 70 mm. A preferred distance is 60 mm. Thus cable 16c may have this length. This makes the control interface easily accessible.

In a preferred embodiment the length of cable 16a is from 150 to 170 mm, the length of cable 16b is from 290 mm to 310 mm and the length of cable 16c is from 50 mm to 70 mm. Distances C₁, C₂, and C₃ may thus have these measurements. This provides a well-balanced and user-friendly device.

However, the control interface 9 may be placed elsewhere on the device.

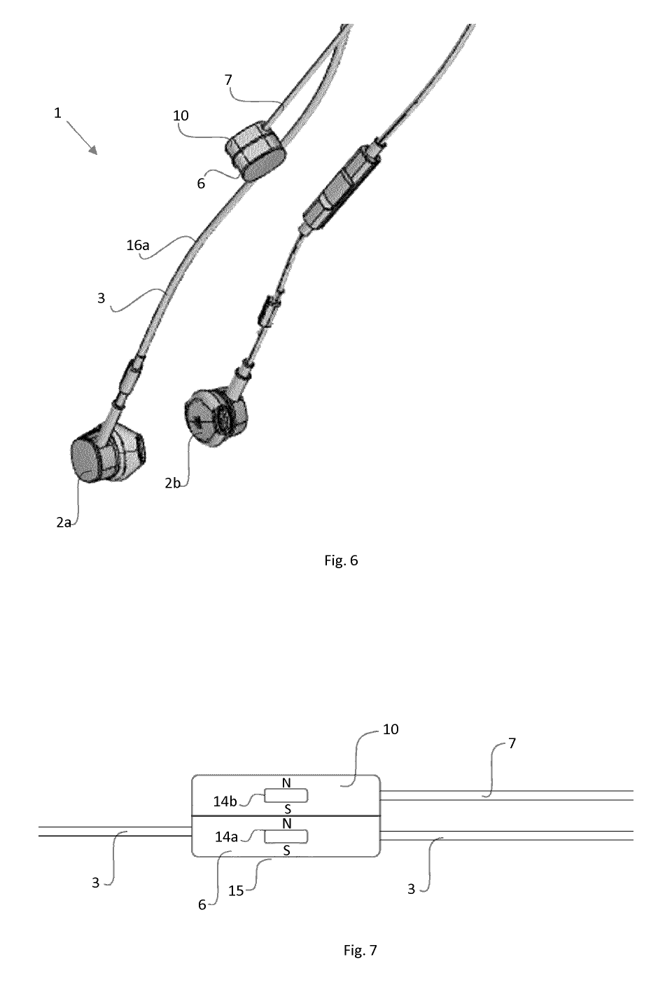

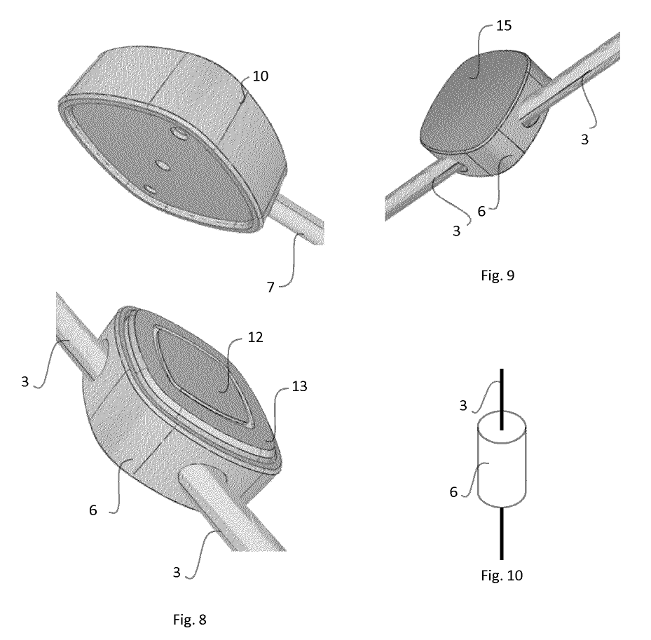

The charging interface 6 may be arranged in different ways. Charging cord 7 comprises charging member 10. Charging member 10 is electrically connected to leads in charging cord 7. The charging interface 6 is arranged to reversibly attach to a charging member 10 as shown in FIG. 1a and FIG. 6 and to form an electrical connection therewith. Thereby a charging current can be led trough charging cable 7 over charging interface 6 to battery 5. There is then an electrical contact between charging member 10 and charging interface 6. At least some surfaces where charging interface 6 and charging member 10 touch are capable of conducting an electrical current. The surfaces may for example be made of a metal material, for example an alloy such as steel. The charging interface 6 should have at least two conducting surfaces 12, 13 connected to respective pole of battery 5 and electrically isolated from each other. Surfaces 12, 13 are arranged to contacting two corresponding conducting and electrically isolated surfaces of charging member 10. The charging interface 6 should connect to charging member 10 so that the polarity of the electrical current is correct, i.e. the plus pole of the charging interface 6 should connect to the plus pole of the charging member 10 and the minus pole of the charging interface 6 should connect to the minus pole of the charging member 10. In FIG. 8 this is achieved by one pole of battery 5 being connected to central surface 12 and the other pole of battery 5 connected to peripheral surface 13.

The charging member 10 may be reversibly attached to charging interface 6 in various manners. The attachment should make the charging member 10 stay connected to the charging interface 6 so that it does not fall off. The attachment should be reversible such that the user easily can remove the charging cable 7.

In a preferred embodiment the charging member 10 is reversibly attached to charging interface 6 with a magnetic force. This has the advantage that the charging member 10, when held by the user, is guided to charging interface 6 by the use of a magnetic force. An advantage with this is that it makes it easier for the user to connect the charging member 10 without visual guidance. This is because when the charging interface 6 rests on the shoulder (as in FIGS. 1a and 1c) or the back of the neck, the user cannot see the charging interface 6.

The magnetic force is provided by at least one magnet 14a in charging interface 6 or magnet 14b in charging member 10. There may be one magnet 14a in the charging interface 6 and one magnet 14b in charging member 10. Suitably these have their N and S poles in the same direction when charging member 10 is attached, as in FIG. 7. The at least one magnet 14 may be a permanent magnet. When the magnet 14a, 14b is integrated in only one of charging interface 6 or charging member 10, the other of charging interface 6 and charging member 10 is suitable comprises a metal part made of a metal to which the magnet 14a, 14b is attracted, for example an iron-containing metal.

FIG. 8 shows how a charging interface 6 and a charging member 10 may be arranged so that they are easily connected with the aid of a magnetic force. The holes of charging member 10 may house protruding pins (not shown), made in a conductive material, that connect to surfaces 12 or 13.

Preferably the charging interface 6 is flat and has a flat underside 15 (the side opposite to the where the charging member 10 attaches) as in FIG. 9. Preferably the charging interface 6 has a flat design and has a low center of gravity. This keeps the outer side of charging interface 6 directed out from the body of the user. This has the advantage of making it easier to connect charging member 10.

The charging member 10 may be attached (reversibly attached) to charging interface 6 by other means, for example a press fit or with a locking mechanism.

The charging interface 6 may have other shapes than shown in the FIGS. 1-9. For example, it may be cylindrical as in FIG. 10. The charging member 10 may then be claw-shaped and be able to grip around a part of the charging interface 6 with a close fit, and may then attach with a magnetic force as described above, or with a press fit.

In a preferred embodiment the sound signal to the headphones and the sound playback is not interrupted when the charging member 10 is attached to the charging interface 6. Thus, the device 1 is configured not to reboot or to shut down when charging member 10 is attached to the charging interface 6. Many Bluetooth devices are programmed to reset, reboot or shut down when the charging cable is connected to the device. Thus preferably the device 1 is configured not to reset, shut down or reboot when the charging member 10 is attached to the charging interface 6.

It should be noted that the battery 5 may be located in either the earbud 2b closest to the charging interface 6 or the earbud 2a farthest away from the charging interface 5.

1. Wearable device for listening to sound, the device comprising:
a first in-ear earbud configured to reproduce sound; and
a second in-ear earbud configured to reproduce sound, wherein said first and said second in-ear earbuds are attached to each other with a cord,
wherein said device having a wireless connection unit configured to receive a wireless digital signal and provide a wire bound signal to the first and second in-ear earbuds for reproducing sound in the first and second in-ear earbuds, and
wherein said device having a battery and a charging interface for reversibly connecting a charging cable for charging the battery.

2. The wearable device according to claim 1, wherein the distance from the charging interface to the first earbud is from 120 mm to 200 mm.

3. The wearable device according to claim 1, wherein the distance from the charging interface to the first earbud is from 140 mm to 180 mm.

4. The wearable device according to claim 1, wherein the first and second in-ear earbuds do not cease to emit sound when the charging cable is connected to the charging interface.

5. The wearable device according to claim 1, wherein a charging cable can be reversibly attached to the charging interface using magnetically attractive force.

6. The wearable device according to claim 1, further comprising a control interface.

7. (canceled)

8. The wearable device according to claim 1, wherein said cord comprises leads for powering the device and for transmitting signals.

9. The wearable device according to claim 1, wherein the length of said device is configured to reach around the back of the neck of a user.

10. The wearable device according to claim 1, wherein the charging interface is located on the cord at a distance from the first earbud to the charging interface of between 100 mm to 220 mm such that the charging interface, when the device is worn by a user, will rest on the shoulder of the user.

11. System configured for listening to sound, the system comprising:
a battery;
a charging interface;
a wireless connection unit;
a first earbud configured to reproduce sound; and
a second earbud configured to reproduce sound, wherein said first and said second earbuds are attached to each other with a cord,
wherein the battery and charging interface are connected to the cord,
wherein the wireless connection unit is connected to either the first earbud or the second earbud,
wherein the wireless connection unit is configured to receive a wireless digital signal and provide a wire bound signal to the first and second earbuds for reproducing sound in the first and second earbuds, and
wherein the battery and the charging interface are configured to reversibly connecting a charging cable for charging the battery.

12. The system according to claim 11, wherein the distance from the charging interface to the first earbud is from 120 mm to 200 mm.

13. The system according to claim 11, wherein the distance from the charging interface to the first earbud is from 140 mm to 180 mm.

14. The system according to claim 11, wherein the first and second earbuds do not cease to emit sound when the charging cable is connected to the charging interface.

15. The system according to claim 11, wherein a charging cable can be reversibly attached to the charging interface using magnetically attractive force.

16. The system according to claim 11, further comprising a control interface.

17. The system according to claim 16, wherein the control interface is located on the cord between the first earbud and the second earbud.

18. The system according to claim 11, wherein said cord comprises leads for powering the device and for transmitting signals.

19. The system according to claim 11, wherein the length of said device is configured to reach around the back of the neck of a user.

20. The system according to claim 11, wherein the charging interface is located on the cord at a distance from the first earbud to the charging interface of between 100 mm to 220 mm such that the charging interface, when the device is worn by a user, will rests lateral to the user's head.
